(19) United States
(12) Patent Application Publication
(10) Pub. No.: US 2023/0332338 A1
(43) Pub. Date: Oct. 19, 2023

(54) METHOD OF POWER CONTROL FOR A TEXTILE MACHINE, POWER CONTROL UNIT AND SPINNING MACHINE

(71) Applicant: Saurer Spinning Solutions GmbH & Co. KG, Uebach-Palenberg (DE)

(72) Inventors: Michael SPITZER, Monschau-Kalterherberg (DE); Robert GEISLER, Wegberg (DE)

(21) Appl. No.: 18/298,609

(22) Filed: Apr. 11, 2023

(30) Foreign Application Priority Data
Apr. 13, 2022 (DE) 102022109107.4

(51) Int. Cl. D01H 4/44; G05B 19/4155; H02J 3/00

(52) U.S. Cl. CPC D01H 4/44; G05B 19/4155; H02J 3/003; G05B 2219/45196

(57) ABSTRACT

A method of power control for a textile machine with simultaneously operated workstations and with at least one power supply unit for jointly powering the workstations, a power control unit and a spinning machine. The method enables rapid run-up of the textile machine and minimise delays and downtimes. The method comprises steps that initially involve determining the required electrical power output of each of the workstations, then determining the simultaneously executable operations on the basis of the determined required power and a maximum power output of the power supply unit. Optimised operating data of the several workstations powered jointly by a power supply unit can be obtained in order to make the best possible use of the maximum power output of a power supply unit, wherein the required electrical power output and/or the simultaneously executable operations are determined, and/or optimised operating data is obtained taking into consideration current batch data.

### CROSS-REFERENCE TO RELATED APPLICATION

This claims priority from Germany Application No. 102022109107.4, filed Apr. 13, 2022, the disclosure of which is hereby incorporated by reference in its entirety.

### FIELD OF THE INVENTION

The invention relates to a method of power control for a textile machine with several simultaneously operated workstations and with at least one power supply unit for jointly powering the several workstations, a power control unit for such a textile machine, and a spinning machine with such a power control unit.

### BACKGROUND OF THE INVENTION

Textile machines and in particular spinning machines are known variously from the prior art and are customarily used in the production of yarn from fibre material. A spinning machine usually has several workstations, each with an electrically driven spinning rotor for spinning the yarn. The spinning machine and in particular the electrical motors of the spinning rotors are powered via at least one power supply unit, with several workstations respectively, for example four workstations, being powered by a joint power supply unit.

In the regular spinning operation, this distribution of the electrical power output from a power supply unit among several workstations of a spinning machine does not usually present a challenge. However, the spinning rotors are operated at a very high speed which is normally in excess of 200,000 r.p.m. for which high electrical power is necessary because of the mass of the spinning rotor to be accelerated when running up the spinning rotor, so that the joint power supply unit is unable to supply sufficient power for all the spinning rotors to be run up at the same time.

It is therefore usual to start the spinning rotors operated jointly by a power supply unit sequentially, wherein the next spinning rotor is only started once the previous spinning rotor has been fully run up. This typically takes substantially longer than one minute per spinning rotor, so that the entire spinning machine is only operable after a lengthy run-up process; this delays the operating sequence when piecing and delays the run-up of several workstations after a malfunction.

### SUMMARY OF THE INVENTION

An object of the invention is therefore to provide a method of power control for a textile machine, a power control unit for such a textile machine, and a spinning machine with such a power control unit, which allow the rapid run-up of the textile machine and correspondingly minimise delays and downtimes in the operating sequence.

The object of the invention is achieved by a method of power control for a textile machine, a power control unit for such a textile machine and a spinning machine with said power control unit.

A method according to an embodiment of the invention of power control for a textile machine with several simultaneously operated workstations and with at least one power supply unit for jointly powering the several workstations comprises the process steps of initially determining the required electrical power for each of the workstations, followed by determining the simultaneously executable operations, in particular of the workstations which can be simultaneously started or run up, based on the determined required power and a maximum power output of the power supply unit. In addition, optimised operating data of the several workstations powered jointly by a power supply unit is obtained in order to make the best possible use of the maximum power output of a power supply unit, wherein the required electrical power output and/or the simultaneously executable operations are determined, and/or optimised operating data is obtained taking into consideration the current batch data.

A power control unit according to an embodiment of the invention for a textile machine with several simultaneously operated workstations and with at least one power supply unit for jointly powering several workstations is provided in order to determine the required electrical power of each of the workstations, the simultaneously executable operations, in particular the workstations capable of being started or run up simultaneously, based on the determined required power and further based on a maximum power output of the power supply unit, and optimised operating data of the plurality of workstations powered jointly by a power supply unit, in order to make the best possible use of the maximum power output of the power supply unit, wherein the determination of the required electrical power and/or the determination of the simultaneously executable operations and/or the provision of optimised operating data is achieved taking into consideration the current batch data.

Finally, an embodiment of the invention also relates to a spinning machine with a power control unit, particularly a power control unit according to an embodiment of the invention, with several simultaneously operated workstations each with a spinning rotor as well as with at least one power supply unit for jointly powering several workstations, the power control unit being provided such that it determines the required electrical power of each of the workstations, the spinning rotors to be simultaneously run up and/or operated on the basis of the determined required power as well as a maximum power output of the power supply unit, and optimised operating data of the plurality of workstations powered jointly by a power supply unit, in order to make the best possible use of the maximum power output of the power supply unit, wherein the determination of the required power and/or the determination of the spinning rotors to be simultaneously run up or operated and/or the provision of optimised operating data is achieved taking into consideration the current batch data.

The inventors have recognised that the run-up time of each spinning rotor depends on the parameters and data of the batch and that therefore power control independent of the batch cannot be performed successfully. Conversely, a consideration of the batch data in directing the run-up of the spinning rotors as well as, where applicable, the starting of other components of the workstation makes it possible in an advantageous manner to optimise the machine run-up time, i.e. the time until the full operating readiness of all the workstations, so that the textile machine is ready for operation much sooner. However, individual workstation downtimes can be reduced even during the regular operation of the textile machine, because the method according to an embodiment of the invention enables faster run-up of temporarily halted workstations during the operation of the other workstations.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a schematic view of a textile machine of an embodiment of the present invention.

FIG. 2 is a flow chart of a method of power control of an embodiment of the present invention.

### DETAILED DESCRIPTION

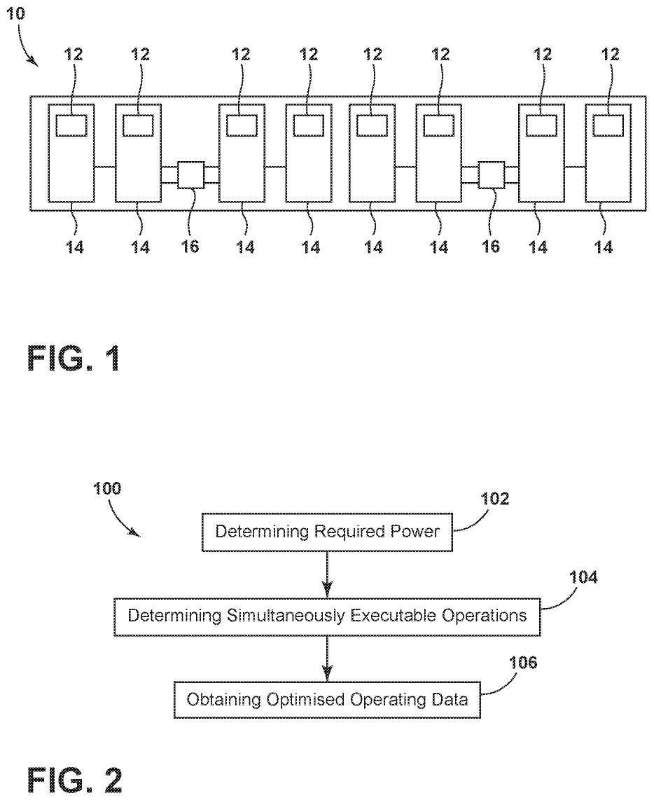

A textile machine 10 as illustrated in FIG. 1 may basically be any machine that processes and/or manufactures a textile product. The textile machine 10 is preferably a spinning machine, particularly preferably a rotor spinning machine, and quite particularly preferably an open-end rotor spinning machine.

The textile machine 10 has several workstations 12 according to an embodiment of the invention which are preferably identical in design to one another. Each workstation 12 in this case has at least one, and preferably several, electrical consumers 14 wherein particularly preferably all workstations 12 are identical in design, at least with regard to their electrical consumers 14. In principle, the electrical consumers 14 of several workstations 12 may, however, also differ from one another, or a workstation 12 may have additional consumers 14. In the case of a workstation 12 for a spinning machine, a substantial electrical consumer is an electric motor, and in particular an electric drive motor of a spinning rotor.

In addition to electrical consumers 14 associated with an additional workstation 12, there may also be electrical consumers 14, for example means for generating low pressure, service carriages, control units, cleaning units or the like, which are jointly associated not with a specific workstation 12, but with several workstations 12. Such joint consumers 14 can be operated by a separate power supply unit or by a power supply unit independent of the power supply unit of the workstations, or however may also be integrated into the power supply of the workstations, and in particular may then be operated by a power supply unit 16 associated with several workstations 12. In this case, the joint consumers 14 must then also be taken into account in the case of a corresponding example of the method of power control according to an embodiment of the invention.

Preferably, however, all the workstations 12 have at least one electrical consumer 14 and in particular one electrically driven spinning rotor that is operated by a joint power supply. A joint power supply is intended to mean that at least one consumer 14 out of several workstations 12 is connected to a joint power supply unit 16 and thus has to be operated jointly by the available total or rated power of the power supply unit 16. In this case, the power supply unit 16 can be any kind of power supply unit 16. The power supply unit 16 is preferably a spinning station power supply unit 16 for several workstations 12 of a spinning machine 10, preferably for between 2 and 10 spinning stations 12, particularly preferably for between two and six spinning stations 12 and quite particularly preferably for four spinning stations 12 of a spinning machine 10 (as illustrated schematically in FIG. 1).

The method 100 (see FIG. 2) according to an embodiment of the invention provides for, as the first process step 102, the determination of the required electrical power of each of the workstations 12, wherein this may be done practically, in particular by current and/or previous power measurements, as well as theoretically, in particular on the basis of the rated data of the consumers 14, on the basis of the power requirement values stored in databases and/or on the basis of power calculations. A combination of value measurements and the use of stored data is also conceivable. Overall, the determination of the required electrical power output of each of the workstations 12 has the purpose of determining how high the power requirement of the operation to be executed is, for example running up a spinning rotor 14. For this, it is basically adequate to determine a number of characteristic values, such as the maximum power consumption, although it is preferable to record and/or analyse the entire chronological sequence of the power consumption.

Once the required power has been determined at step 102 and the maximum power output of the power supply unit 16 is known, according to an embodiment of the invention the operations that can be executed simultaneously are determined at step 104, without the maximum power output of the power supply unit 16 being exceeded at any time during the planned operations. As maximum power output of the power supply unit 16, preferably the rated power of the power supply unit 16 or the actual maximum power that can be made available is used.

In addition, according to an embodiment of the invention, in a process step with the determination of the simultaneously executable operations, or directly thereafter, optimised operating data is provided at step 106 of the several workstations 12 jointly supplied by a power supply unit 16 in order to make the best possible use of the maximum power output of the power supply unit 16.

The operating data for this may be any data concerning the operation of the workstations 12, preferably at least of an electrical consumer 14 operated by the power supply unit 16, particularly preferably of all electrical consumers 14 operated by the power supply unit 16, and quite particularly preferably of all electrical consumers 14 of the workstations 12. Here, the operating data may include in particular the chronological sequence of the operations, for example the start time, the run-up duration and/or the operating mode of one or more electrical consumers 14. Quite particularly preferably, the operating data includes the time and/or duration of the piecing and/or the run-up of the spinning rotor motors 14 of a spinning machine 10. Additionally, the shift in the timings of several operations in respect of one another may also form part of the optimisation, for example moving the times of power peaks of the operation(s) to ensure that the maximum power output of the power supply unit 16 is not reached or exceeded at any time.

Correspondingly, the optimised operating data preferably include an optimised control sequence of commissioning and/or operation at least of one workstation 12 or of the at least one electrical consumer 14, preferably of all the workstations 12 connected to the particular power supply unit 16 and quite particularly preferably of the entire textile machine 10, in particular the entire spinning machine 10.

The optimised operating data provided can then be provided for activating the electrical consumers 14 and/or can be transmitted to a corresponding control unit. In doing so, the optimised operating data can already be provided in the control unit, a higher-level control unit or else also in a separate data processing unit. Generally it is preferred that the method 100 according to an embodiment of the invention should run in the central control unit of the textile machine 10.

The illustrated steps of method 100 including determining the required power and/or determining the operations that are simultaneously executable and/or obtaining optimised operating data is achieved according to an embodiment of the invention when taking account of the current batch data, since the batch data affects the required power or power consumption of the particular workstation 12 and hence it is essential to take this into account for good optimisation of the operating data. In particular, there is the danger that because of the current batch the power consumption of the workstations 12 will be higher than average and therefore activation by optimised operating data independent of the batch could result in an overloading of the power supply unit 16, malfunctioning of the workstations 12 or, at worst, damage to the textile machine 10.

It is thus imperative according to an embodiment of the invention to obtain the optimised operating data with reference to the particular batch. Accordingly, it is preferable for the method according to an embodiment of the invention at least to be executed when the batch is changed and/or if the current batch data deviate significantly from the data of the previous and/or from all the previous batches. Accordingly, the required power and/or the operations which can be executed simultaneously are preferably mandatorily determined depending on at least one part of the batch data, and particularly preferably depending on all the substantial batch data, or the optimised operating data obtained correspondingly.

Generally it is preferable for the batch data in question to include spinning parameters, values of the material used for manufacturing the textile and/or machine data. Particularly preferably, the current batch data taken into account include the nature, composition and/or dimensions of the material used for manufacturing the textile, the speed of the drive motor and/or spinning rotor and/or the acceleration of a drive motor when starting the workstation, in particular when running up the spinning rotor or when piecing. In particular, the chemical composition and/or physical properties of the fibre material used, such as fibre length, fibre diameter and/or the blend of various fibre materials, are quite particularly preferred as batch data.

The current batch data are deemed to be the data for the batch just being processed on the textile machine 10, wherein the batch data are preferably dependent on the particular textile machine 10 or particular workstation 12 and/or the particular textile to be manufactured.

However, the required electrical power also remains dependent on the other electrical consumers 14 of the workstation 12 and their activation or operating mode, which can differ from batch to batch and in particular should advantageously also be taken into account.

In an advantageous development of the method of power control according to an embodiment of the invention, the determination of the required electrical power of a workstation 12, and in particular of each workstation 12 powered by the power supply unit 16, is achieved by a test start and/or test operation of the workstation 12, particularly with the current batch data. The test start is preferably a test piecing or a test run-up of the particular workstation 12, and in particular of a spinning rotor of the workstation 12. It is generally sufficient if just one single workstation 12 performs a test start and/or test operation, particularly if the power consumption of each of the workstations 12 is known under standard conditions or during normal operation and thus preferably the power differences arising among the individual workstations 12 during operation can also be theoretically calculated and taken into account accordingly.

However, it is particularly preferable for each individual workstation 12 powered by a power supply unit 16 if a test start and/or test operation can be performed, both sequentially as well as simultaneously for some or all of the workstations 12, provided the power supply unit 16 is able to provide sufficient electrical power. In such test operation it is not material whether individual workstations 12 fail due to an inadequate power supply, so that a test with all workstations 12 can also be attempted at the same time.

In a further advantageous development of the method of power control, the required electrical power of a workstation 12, and in particular of each workstation 12 powered by a power supply unit 16, is determined by monitoring the run-up or start and/or the regular operation of the particular workstation 12, in particular with the current batch data. Particularly when piecing or running up each individual workstation 12 during operation, the power data and in particular the power consumption of the drive motor 14 and/or of the entire workstation 12 is monitored and recorded, analysed and preferably also stored at least once, and preferably at each piecing or run-up. It is particularly preferable to monitor a conventional, mostly sequential run-up of all the spinning rotors 14 of all the workstations 12 or spinning stations 12 powered by a power supply unit 16 and to record and/or analyse the power consumption, particularly its chronological sequence. As an alternative or additionally, the maximum power output or maximum power consumption can also be monitored.

A preferred development of the method of power control according to an embodiment of the invention provides for the determined data of the required power to be stored and linked to the respective batch data in order to enable optimised operating data to be obtained. The data is preferably stored in a database. In particular data from each specific workstation 12, generalised data on all workstations 12 and/or the respective operating parameters and/or results of a test start, test operation and/or monitoring the run-up is stored or entered in the database. The optimised operating data can be obtained immediately after determining the required electrical power or, however, at any later time, by retrieving the data from the database. The database is preferably located in the central control unit of the textile machine 10 or an individual control unit of the textile machine 10 is preferable. However, additionally or as an alternative, it is also conceivable to arrange for the textile machine 10 to communicate with an external database.

To achieve particularly accurate power control, an advantageous development of the method according to an embodiment of the invention envisages that, based on the respective batch data and/or the respective machine settings, as well as the data of the required electrical power stored in a database, a power forecast for the respective planned operating sequence is created, and as part of obtaining optimised operating data it is verified whether the joint power supply unit 16 is able to provide sufficiently high power in order at the same time to facilitate a further operation, for example the run-up of a further workstation 12. Accordingly, the optimised operating data is provided such that the best possible use is made of the available total output, but at the same time that it is ensured that over time a higher power output than the available total or rated power of the power supply unit 16 is never required.

In addition, it is preferable that the required electrical power of each workstation 12 is determined exclusively or additionally based on data stored in a database for similar batch data, so that even for a set of batch data that has not been used so far it is already possible to optimise the operating data based on a similar set of batch data.

Although very accurate control is possible with the method according to an embodiment of the invention, a preferred development of the said method provides for a feedback loop or feedback, it being particularly preferable to optimise the power control by recording the actual power output of the power supply unit 16 during operation of the textile machine 10 with the optimised operating data, and subsequently comparing this to the determined required electrical power and/or to a result of the power forecast, as well as storing the correction data in a database and/or making a correction to other optimised operating data.

A preferred development of the method of power control according to an embodiment of the invention envisages that during operation of the textile machine 10 with the optimised operating data the still available power output of the power supply unit 16 is drawn on and this still available power is then taken into account in the further optimisation of the operating parameters, wherein a check is preferably made as to whether a further workstation 12 is permitted to run up and/or be operated. The still available power output of the power supply unit 16 comprises in particular at any time the difference between the currently actually drawn or provided power and the rated power or the maximum power output of the power supply unit 16.

In addition, it is advantageous if during operation of the textile machine 10 with the optimised operating data the actual power consumption is continuously monitored and in the event of exceeding the value of the power forecast and/or in the case of exceeding a set maximum power preferably an adjustment of the optimised operating data is made and/or a workstation 12 is slowed or shut down, so that operational failure, malfunction or even damage owing to insufficient available power can be avoided.

Several embodiments of the method of power control of a textile machine 10 are described below in detail:

In a first development of such a method the run-up of the spinning stations 12 of a spinning machine 10 is optimised, wherein in each case four spinning stations 12 are powered jointly via a spinning station power supply unit 16. The constant power output of the spinning station power supply unit 16 is 4×300 W with by means of an additional terminal a further 350 W. This rated power of the spinning station power supply unit 16 is sufficient to operate four spinning stations 12 including electrical motors for driving spinning rotors at high speed.

Conversely, for the initial spinning process, i.e. running up the rotor motor, much higher power is required than for regular operation, so that in the prior art a sequential run-up is performed, wherein the first spinning rotor runs up for a duration of 70 seconds and only on reaching its operating speed is the next spinning rotor allowed to run up, which then takes another 70 seconds, so that the entire run-up period for all four spinning rotors amounts to at least 280 seconds.

To optimise the run-up time and the entire operating sequence of the spinning machine 10, particularly running up the spinning rotors, each of the spinning rotors is individually and consecutively allowed to run up during which the chronological sequence of the electrical power output recorded. The power output required for the run-up is then stored in a database in the central control unit of the spinning machine 10 together with the batch data, i.e. the spinning parameters and the machine data, so that for each spinning station 12 the required electrical power output as a factor of the current batch data is known. This can be recorded as a factor of the batch data, because the required power varies considerably with any change in the batch data and thereby depends in particular on the spinning rotor used, the rotor motor, the chosen speed of the spinning rotor as well as other spinning parameters, which in turn have to be selected as a factor of the fibre material to be processed and/or the yarn to be provided, so that for example the yarn thickness to be achieved, yarn strength, material composition of the yarn and the structure of the yarn have a substantial influence on the required electrical power.

Once the required electrical power of the individual spinning stations 12 for an operating sequence, for example the run-up, is known for exactly the current set of batch data, a power forecast can be provided afterwards and in particular it can be calculated how many spinning stations 12 or how many operations can be executed at the same time. From this information, optimised operating data can then be calculated which determine the operating sequence, e.g. a run-up. To achieve this, the starting times of the individual spinning rotors, their acceleration and their run-up time can be varied, for example, so that the constant power or rated power provided by the spinning station power supply unit 16 can be put to the best possible use and in the ideal case the spinning machine 10 can be operated at any time with a high capacity utilisation of the spinning station power supply unit 16.

By this means it is typically possible to have at least two spinning stations 12 running up at the same time, as well as where appropriate to initiate the run-up of further spinning stations 12 before completion of the run-up of the spinning stations 12 which have already been accelerated, by which means the run-up period can typically be reduced by 25%-50%. However, overloading the spinning station power supply unit 16 must be avoided in any case, therefore the power forecast can take account of the batch data which may result in an increased power requirement.

A second development of the method 100 according to an embodiment of the invention only differs from a first development substantially by the fact that the required electrical power output for each of the spinning stations 12 is not determined by a currently performed test run-up, but instead a search is made in the database for the data from a previous test run-up of this spinning station 12 with the identical batch data. If such data is available from identical batch data, it is automatically used. Where no identical data is present, a set of stored batch data that is as similar as possible is searched for and a decision is then made on whether there is sufficient similarity or only a very slight deviation of the batch data. For example, if completely identical machine data are present, i.e. the spinning station 12 of the spinning machine 10 has not been altered, and if the spinning parameters are also almost identical, for example because only different-coloured fibres or fibres with only a very slight difference in chemical composition or fibre length are used, either the values of the required electrical power output of this spinning station 12 recorded for the almost identical set of batch data can be used, or else an interpolation can be made using the altered parameters, particularly by means of numerous database entries. However, if the current batch data for all the batch data stored in the database is too different, a test run-up or sequential run-up will be initiated automatically and thereby the required electrical power recorded. In addition, the data will then be recorded as a new entry for future use in the database.

In a third development of the method 100, exactly as in the previous developments the required electrical power output of each spinning station 12 will be determined and depending on the batch data it will be specified how many spinning stations 12 can be run up at the same time and the corresponding optimised operating data obtained. This operating data is then used in order to have all four spinning stations 12 run up simultaneously. However, the actual recorded electrical power of the spinning stations 12 is continuously played back on the central control unit of the spinning machine 10 which performs the process, where the electrical power actually recorded is compared against the previous forecast and the correlation analysed and also stored in the database in order to improve future forecasts.

In addition, the electrical power output actually recorded is monitored in order to determine whether there is a failure to maintain a safety distance from the maximum rated power of the spinning station power supply unit 16. If this is the case, corrected optimised operating data are immediately determined and applied, which in most cases will result in the run-up spinning of at least one of the spinning stations 12 being delayed, slowed down, or even interrupted in order to prevent the spinning station power supply unit 16 from becoming overloaded.

1-12. (canceled)

13. A method of power control for a textile machine with a plurality of simultaneously operated workstations and with at least one power supply unit for joint power supply of the plurality of simultaneously operated workstations, the method comprising:
determining of a required electrical power of each of the plurality of simultaneously operated workstations;
determining simultaneously executable operations based on the determined required electrical power and a maximum power output of the at least one power supply unit; and
obtaining optimised operating data of the plurality of simultaneously operated workstations powered jointly by the at least one power supply unit in order to make a best possible use of the maximum power output of the at least one power supply unit;
wherein the step of determining of the required electrical power and/or the step of obtaining optimised operating data is obtained taking into consideration current batch data.

14. The method of power control according to claim 13, wherein the current batch data includes a nature, composition and/or dimensions of material used to manufacture the textile machine, a speed of a drive motor and/or of a spinning rotor and/or an acceleration of the drive motor when each of the plurality of simultaneously operated workstations start up.

15. The method of power control according to claim 13, wherein a required electrical power output of each of the plurality of simultaneously operated workstations is determined by a test start and/or test operation of each of the plurality of simultaneously operated workstations with the current batch data.

16. The method of power control according to claim 13, wherein the required electrical power of each of the plurality of simultaneously operated workstations is determined by monitoring a run-up and/or regular operation of a respective one of the plurality of simultaneously operated workstations workstation with the current batch data.

17. The method of power control according to claim 13, wherein the optimised operating data is stored in a database linked to the current batch data in order to enable the optimised operating data to be obtained from the database.

18. The method of power control according to claim 13, wherein a power forecast is prepared for a planned operating sequence based on the current batch data and/or respective machine settings as well as data on a required electrical power stored in a database, and in a context of obtaining optimised operating data the power forecast is checked to determine whether the at least one power supply unit is able to provide sufficient power in order to allow a further operation at the same time.

19. The method of power control according to claim 13, wherein the required electrical power of each of the plurality of simultaneously operated workstations is determined on a basis of data for similar batch data stored in a database.

20. The method of power control according to claim 18, further including optimizing the power control by recording an actual electrical power output of the at least one power supply unit during operation of the textile machine with the optimised operating data and subsequently by a comparison with the determined required electrical power and/or with a result of the power forecast, as well as by storing correction data in a database and/or correcting further optimised operating data when the further optimised operating data is obtained.

21. The method of power control according to claim 13, wherein, during operation of the textile machine with the optimised operating data, still available power output of the at least one power supply unit is drawn and subsequently taken into account in further optimisation of operating parameters, wherein the further optimisation of operating parameters is checked whether a further workstation is permitted to be run up and/or can be operated.

22. The method of power control according to claim 13, wherein, during operation of the textile machine with the optimised operating data, actual power consumption is continuously monitored and if a value of a power forecast and/or of a set maximum power output is exceeded, the optimised operating data is adjusted and/or at least one of the plurality of simultaneously operated workstations is slowed or shut down.

23. A power control unit for a textile machine with a plurality of simultaneously operated workstations and with at least one power supply unit for joint power supply of the plurality of simultaneously operated workstations, wherein the power control unit:
determines a required electrical power of each of the plurality of simultaneously operated workstations;
determines a simultaneously executable operations based on the determined required power as well as on a maximum power output of the at least one power supply unit; and
obtains optimised operating data of the plurality of simultaneously operated workstations powered jointly by the at least one power supply unit in order to make a best possible use of the maximum power output of the at least one power supply unit;
wherein the required electrical power is determined and/or optimised operating data is obtained taking into consideration current batch data.

24. A spinning machine with the power control unit according to claim 23, wherein each of the plurality of simultaneously operated workstations each of which has a spinning rotor, the at least one power supply unit jointly powers the plurality of simultaneously operated workstations, the at least one power control unit is provided such that the at least one power control unit determines the required electrical power of each of the plurality of simultaneously operated workstations, determines the spinning rotors to be simultaneously run up and/or operated on a basis of the determined required power as well as of a maximum power output of the at least one power supply unit, and obtains optimised operating data on the plurality of simultaneously operated workstations supplied jointly by the at least one power supply unit, in order to make a best possible use of the maximum power output of the at least one power supply unit, wherein the required power is determined and/or optimised operating data is obtained taking into consideration the current batch data.
